(19) United States
(12) Patent Application Publication
(10) Pub. No.: US 2022/0113479 A1
(43) Pub. Date: Apr. 14, 2022

(54) TERMINAL PORTION STRUCTURE OF OPTICAL TRANSMISSION ELEMENT

(71) Applicant: TAIWAN CLOUD LIGHT TECHNOLOGY LIMITED, New Taipei City (TW)

(72) Inventors: EN-HUNG LIN, New Taipei City (TW); CHANG-HUNG TIEN, New Taipei City (TW); BO-HONG MA, New Taipei City (TW); JUI-TING TSAI, New Taipei City (TW)

(21) Appl. No.: 17/137,316

(22) Filed: Dec. 29, 2020

(30) Foreign Application Priority Data
Oct. 8, 2020 (TW) 109135064

(51) Int. Cl. G02B 6/42

(52) U.S. Cl. CPC G02B 6/4206; G02B 6/4214; G02B 6/4243

(57) ABSTRACT

A terminal portion structure of an optical transmission element includes a light guiding component, glass protection layer and convex lens. The light guiding component includes a core and a cladding enclosing the core. The cladding is of a lower refractive index than the core, allowing light signals to be transmitted in the light guiding component by total internal reflection. The glass protection layer covers at least a terminal portion of the light guiding component. The convex lens is disposed on one side of the glass protection layer. The cross section of the terminal portion of the light guiding component tilts relative to the axial direction of the light guiding component. The optical axis of the convex lens is perpendicular to the axial direction of the light guiding component. The focal point of the convex lens is located at the cross section of the terminal portion of the core.

### CROSS-REFERENCE TO RELATED APPLICATION

This non-provisional application claims priority under 35 U.S.C. § 119(a) on Patent application No(s).109135064 filed in Taiwan, R.O.C. on Oct. 8, 2020, the entire contents of which are hereby incorporated by reference.

### BACKGROUND OF THE INVENTION

### 1. Field of the Invention

The present disclosure relates to optical transmission elements, and in particular to a terminal portion structure of an optical transmission element.

### 2. Description of the Related Art

Optical fibers are fibers made of glass or plastic. Light travels in optical fibers by total internal reflection. By contrast, planar lightwave circuits are made of glass and silicon by a semiconductor manufacturing process (including deposition and etching). Light also travels in planar lightwave circuits by total internal reflection. Optical fibers and planar lightwave circuits, also known as optical transmission elements, have better modulation rate and longer transmission distance than cables in electrical signal transmission. Therefore, to transmit signals, a laser emission element converts electrical signals into light signals and sends the light signals to the emission end of the optical transmission element. The light signals travel to the output end of the optical transmission element before being emitted therefrom toward a light signal receiving element. The light signal receiving element converts the light signals into electrical signals.

However, both the laser emission element and light signal receiving element hardly permit the tolerance of the distance between an optical fiber (or a planar lightwave circuit) and another optical fiber (or another planar lightwave circuit), leading to difficulties in assembly. For instance, the laser emission element and/or light signal receiving element must be spaced apart from the optical transmission element by a distance of 20 to 40 μm; thus, during the process of aligning two components, the tips of the optical fibers or the surfaces of the aforesaid optoelectronic components are likely to be damaged. To overcome this drawback, the prior art teaches grinding the surface of the terminal portion of the optical transmission element at an angle of 45 degrees, allowing the optoelectronic components to send light signals toward the inclination surface of 45 degrees or receive light signals therefrom. However, the aforesaid conventional technique requires precise control of the grinding of the optical transmission elements. Therefore, the prior art is still unable to eradicate the difficulties in manufacturing and assembly.

### BRIEF SUMMARY OF THE INVENTION

An objective of the present disclosure is to provide a terminal portion structure of an optical transmission element.

To achieve at least the above objective, the present disclosure provides a terminal portion structure of an optical transmission element, comprising: a light guiding component comprising a core and a cladding enclosing the core, wherein refractive index of the cladding is less than refractive index of the core, allowing light signals to be transmitted in the light guiding component by total internal reflection; a glass protection layer covering at least the terminal portion of the light guiding component; and a convex lens disposed on a side of the glass protection layer, wherein a cross section of the terminal portion of the light guiding component tilts relative to an axial direction of the light guiding component, and an optical axis of the convex lens is perpendicular to the axial direction of the light guiding component.

In an embodiment of the present disclosure, the focal point of the convex lens is located at the cross section of the terminal portion of the core.

In an embodiment of the present disclosure, an included angle between the cross section of the terminal portion of the light guiding component and the axial direction of the light guiding component is less than 44 degrees.

In an embodiment of the present disclosure, further comprising a laser emission element facing the convex lens.

In an embodiment of the present disclosure, further comprising a light signal receiving element facing the convex lens.

In an embodiment of the present disclosure, the light guiding component is in a plural number, and the light guiding components are arranged in parallel, with the glass protection layer covering at least the terminal portions of the light guiding components.

In an embodiment of the present disclosure, the glass protection layer has a plurality of V-shaped grooves parallel to the light guiding components.

The present disclosure further provides a terminal portion structure of an optical transmission element, comprising: a light guiding components comprising a core and a cladding enclosing the core, wherein refractive index of the cladding is less than refractive index of the core, allowing light signals to be transmitted in the light guiding component by total internal reflection; a glass protection layer covering at least the terminal portion of the light guiding component; and a convex lens disposed at the cross section of the terminal portion of the light guiding component, wherein the cross section of the terminal portion of the light guiding component is perpendicular to an axial direction of the light guiding component, and an optical axis of the convex lens is parallel to the axial direction of the light guiding component.

In an embodiment of the present disclosure, the focal point of the convex lens is located at the core.

In an embodiment of the present disclosure, the convex lens adjoins the cross section of the terminal portion of the light guiding component.

In an embodiment of the present disclosure, further comprising a pad disposed at the convex lens and on the cross section of the terminal portion of the light guiding component.

The present disclosure further provides a terminal portion structure of an optical transmission element, comprising: a light guiding components comprising a core and a cladding enclosing the core, wherein refractive index of the cladding is less than refractive index of the core, allowing light signals to be transmitted in the light guiding components by total internal reflection, wherein the cross section of the terminal portion of the light guiding component is perpendicular to an axial direction of the light guiding component; a glass protection layer covering at least the terminal portion of the light guiding component; and a prismatic convex lens disposed at the terminal portion of the light guiding component and having a connecting side, a convex side and a reflecting side opposing the connecting side, the connecting side adjoining the cross section of the terminal portion of the light guiding component, the reflecting side tilting relative to an axial direction of the light guiding component, and the convex side defining a convex lens, wherein an optical axis of the convex lens is perpendicular to an axial direction of the light guiding component.

In an embodiment of the present disclosure, the prismatic convex lens is an integrally formed prism.

In an embodiment of the present disclosure, the prismatic convex lens is a combination of a multi-faceted prism and a convex lens.

In an embodiment of the present disclosure, an included angle between the reflecting side and the axial direction of the light guiding component is less than 44 degrees.

According to the present disclosure, the terminal portion structure of an optical transmission element increases the tolerance of the distance between the laser emission element or light signal receiving element and the light guiding component, increases the tolerance of the inclination angle of the cross section of the terminal portion of the light guiding component, broadens the application of the terminal portion structure of an optical transmission element to various laser emission elements or light signal receiving elements, renders assembly and manufacturing easy, and downsizes related elements.

### BRIEF DESCRIPTION OF THE DRAWINGS

FIG. 1 is a cross-sectional view of a terminal portion structure of an optical transmission element according to the first embodiment of the present disclosure.

FIG. 2 is a cross-sectional view of the terminal portion structure of an optical transmission element according to the second embodiment of the present disclosure.

FIG. 3 is a cross-sectional view of another aspect of the terminal portion structure of an optical transmission element according to the second embodiment of the present disclosure.

FIG. 4 is a cross-sectional view of the terminal portion structure of an optical transmission element according to the third embodiment of the present disclosure.

FIG. 5 is a cross-sectional view of another aspect of the terminal portion structure of an optical transmission element according to the third embodiment of the present disclosure.

FIG. 6 is a perspective view of a plurality of light guiding components arranged in parallel according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

The present disclosure provides a terminal portion structure 100 of an optical transmission element. The optical transmission element is in the form of optical fiber (mainly made of glass) or planar lightwave circuit (usually comprising glass and silicon and manufactured by a semiconductor manufacturing process), but the present disclosure is not limited thereto. The optical transmission element is any optical element capable of transmitting light signals by a refractive index.

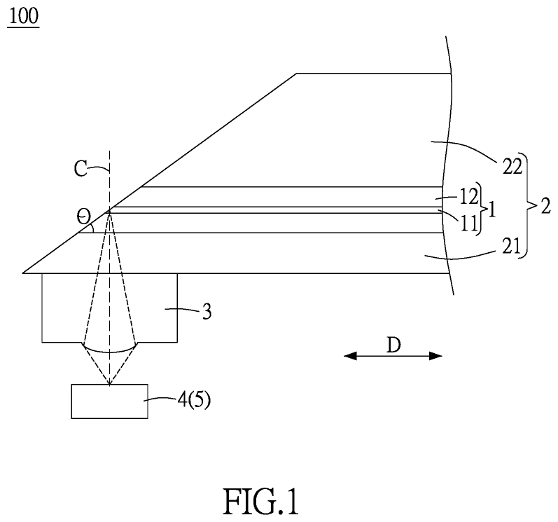

As shown in FIG. 1, in the first embodiment of the present disclosure, a terminal portion structure 100 of an optical transmission element comprises a light guiding component 1, a glass protection layer 2 and a convex lens 3.

The light guiding component 1 comprises a core 11 and a cladding 12 enclosing the core 11. The refractive index of the cladding 12 is less than the refractive index of the core 11, allowing light signals to be transmitted in the light guiding component 1 by total internal reflection.

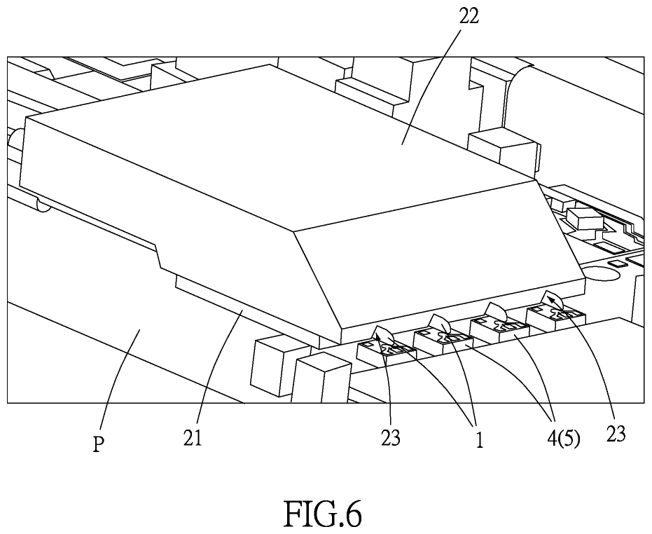

The glass protection layer 2 covers at least the terminal portion of the light guiding component 1. According to the present disclosure, the glass protection layer 2 includes a lower lid 21 and an upper lid 22. The lower lid 21 and the upper lid 22 are coupled together to fully enclose the light guiding component 1. In this embodiment, the difference between the “upper” part and the “lower” part is defined by the direction in which the terminal portion structure 100 of an optical transmission element and a circuit board P are coupled together (as shown in FIG. 6). The part coupled to or facing the circuit board P is the lower lid 21. The part facing outward is the upper lid 22. However, the present disclosure is not limited thereto, and the glass protection layer 2 may be integrally formed to enclose the light guiding component 1.

Referring to FIG. 1, the convex lens 3 is disposed on one side of the glass protection layer 2. In this embodiment, the convex lens 3 is disposed at the lower lid 21, and the cross section of the terminal portion of the light guiding component 1 tilts relative to the axial direction D of the light guiding component 1, thereby forming an included angle θ therebetween. The optical axis C of the convex lens 3 is perpendicular to the axial direction of the light guiding component 1. The focal point of the convex lens 3 is located at the cross section of the terminal portion of the core 11. However, the present disclosure is not limited thereto, as the location of the focal point is adjustable according to the grinding angle and the point of attachment to the convex lens 3, so as to effectively prevent the reflecting light from returning to the original optical fiber or wave guiding path.

According to the present disclosure, the terminal portion structure 100 of an optical transmission element is not limited to the emission end or output end, as light signals may enter the light guiding component 1 via the terminal portion structure 100 of an optical transmission element, or light signals in the light guiding component 1 may be emitted from the terminal portion structure 100 of an optical transmission element.

When light signals travel from a laser emission element 4 to the convex lens 3, the laser emission element 4 can be regarded as a point source. The light signals emitted from the point source are converged by the convex lens 3 onto the cross section of the terminal portion of the core 11. The cross section of the terminal portion of the light guiding component 1 tilts relative to the axial direction D of the light guiding component 1, such that the light signals undergo total internal reflection on the cross section and propagate in the axial direction D of the light guiding component 1 toward the remote end.

By contrast, when light signals from the remote end propagate in the axial direction D of the light guiding component 1 toward the terminal portion structure 100 of an optical transmission element, the light signals come into contact with the oblique cross section of the terminal portion of the light guiding component 1 and thus propagate at all angles toward the convex lens 3. The convex lens 3 converges the multi-angle propagating light signals at a light signal receiving element 5.

According to the present disclosure, the terminal portion structure 100 of an optical transmission element converges light signals at a focal point with the convex lens 3 to increase the tolerance of the distance between the laser emission element 4 or light signal receiving element 5 and the light guiding component 1, increase the tolerance of the inclination angle of the cross section of the terminal portion in the light guiding component 1, broaden the application of the terminal portion structure 100 of an optical transmission element to various laser emission elements 4 or light signal receiving elements 5, render assembly and manufacturing easy, and downsize related elements. According to the present disclosure, the terminal portion structure 100 of an optical transmission element is applicable to multiwave multiplexing (sending beams of light signals of different wavelengths simultaneously from one single optical fiber or wave guiding) and multiwave demultiplexing (dividing a group of light signals of different wavelengths into several light signals of specific wavelength), but the present disclosure is not limited to one single optical fiber or wave guiding transmission.

In this embodiment, the included angle θ between the cross section of the terminal portion of the light guiding component 1 and the axial direction of the light guiding component is less than 44 degrees. Considering a malfunction caused by the reflecting light effect of incident light and emitting light, the included angle θ is preferably 42.5±0.5 degrees.

In this embodiment, the terminal portion structure 100 of an optical transmission element further comprises the laser emission element 4 facing the convex lens 3. The laser emission element 4 is, for example, a vertical-cavity surface-emitting laser (VCSEL) for converting electrical signals into laser of fixed wavelength and outputting it.

In this embodiment, the terminal portion structure 100 of an optical transmission element further comprises the light signal receiving element 5 facing the convex lens 3. The light signal receiving element 5 is a photodiode (PD) for converting light signals into electrical signals.

In this embodiment, as shown in FIG. 6, the light guiding component 1 is in a plural number. The light guiding components 1 are arranged in parallel. The glass protection layer 2 covers at least the terminal portions of the light guiding components 1.

In this embodiment, as shown in FIG. 6, the glass protection layer 2 has a plurality of V-shaped grooves parallel to the light guiding components 1 to serve as markers for use in mounting the light guiding components 1 in place.

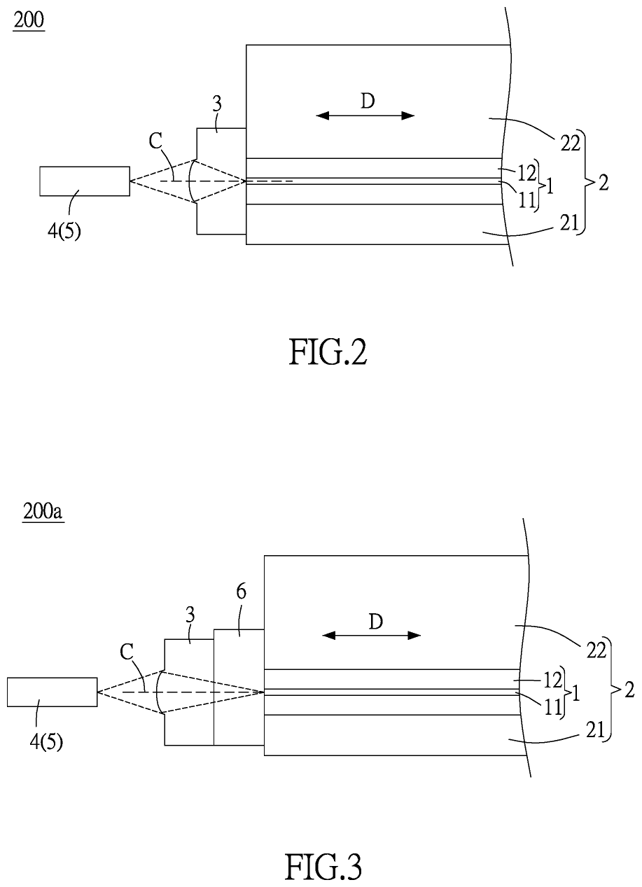

The present disclosure further provides the second embodiment. As shown in FIG. 2, a terminal portion structure 200 of an optical transmission element comprises a light guiding components 1, a glass protection layer 2 and a convex lens 3.

The light guiding components 1 comprises a core 11 and a cladding 12 enclosing the core 11. The refractive index of the cladding 12 is less than the refractive index of the core 11, allowing light signals to be transmitted in the light guiding components 1 by total internal reflection.

The glass protection layer 2 covers at least the terminal portion of the light guiding component 1. According to the present disclosure, the glass protection layer 2 is divided into a lower lid 21 and an upper lid 22. The lower lid 21 and the upper lid 22 are coupled together to fully enclose the light guiding component 1. However, the present disclosure is not limited thereto, the glass protection layer 2 may be integrally formed to enclose the light guiding components 1.

Technical features which distinguish the second embodiment from the first embodiment are as follows: the cross section of the terminal portion of the light guiding component 1 is perpendicular to the axial direction D of the light guiding component 1; the convex lens 3 is disposed at the cross section of the terminal portion of the light guiding component 1; and the optical axis C of the convex lens 3 is parallel to the axial direction D of the light guiding components 1.

According to the present disclosure, the terminal portion structure 200 of an optical transmission element is not limited to the emission end or output end, as light signals may enter the light guiding component 1 via the terminal portion structure 200 of an optical transmission element, or the light signals in the light guiding components 1 may be emitted from the terminal portion structure 200 of an optical transmission element.

When light signals are emitted from a laser emission element 4 toward the convex lens 3, the laser emission element 4 can be regarded as a point source. The light signals emitted from the point source are converged by the convex lens 3 onto the core 11, such that the light signals undergo total internal reflection in the light guiding components 1 and propagate in the axial direction D of the light guiding components 1 toward the remote end.

By contrast, when the light signals from the remote end propagate in the axial direction D of the light guiding components 1 toward the terminal portion structure 200 of an optical transmission element, the light signals come into contact with the cross section of the terminal portion of the light guiding component 1 and thus propagate at all angles toward the convex lens 3. The convex lens 3 converges the multi-angle propagating light signals at a light signal receiving element 5.

According to the present disclosure, the terminal portion structure 200 of an optical transmission element converges light signals at the core 11 with the convex lens 3 to increase the tolerance of the distance between the laser emission element 4 or light signal receiving element 5 and the light guiding component 1, broaden the application of the terminal portion structure 200 of an optical transmission element to various laser emission elements 4 (for example, edge-emitting semiconductor lasers and distributed feedback lasers) or light signal receiving elements 5, render assembly and manufacturing easy, and downsize related elements. According to the present disclosure, the terminal portion structure 200 of an optical transmission element is applicable to multiwave multiplexing (sending beams of light signals of different wavelengths simultaneously from one single optical fiber or wave guiding) and multiwave demultiplexing (dividing a group of light signals of different wavelengths into several light signals of specific wavelength), but the present disclosure is not limited to one single optical fiber transmission.

In this embodiment, the focal point of the convex lens 3 is located at the core 11. However, the present disclosure is not limited thereto, as the location of the focal point is adjustable according to the grinding angle and the point of attachment to the convex lens 3, so as to effectively prevent the reflecting light from returning to the original optical fiber or wave guiding path.

In an aspect of this embodiment, the convex lens 3 of the terminal portion structure 200 of an optical transmission element adjoins the cross section of the terminal portion of the light guiding component 1. However, the present disclosure is not limited thereto. As shown in FIG. 3, in another aspect of this embodiment, the terminal portion structure 200 of an optical transmission element further comprises a pad 6 disposed at the convex lens 3 and on the cross section of the terminal portion of the light guiding component 1 to operate in conjunction with the convex lens 3 in adjusting the emitting/receiving distance of the laser emission element 4 or the light signal receiving element 5. The pad 6 is preferably made of glass which matches the convex lens 3 and the light guiding components 1 in terms of refractive index. However, the present disclosure is not limited thereto, as the pad 6 can be made of any medium material which manifests no absorption within a range of operating wavelength.

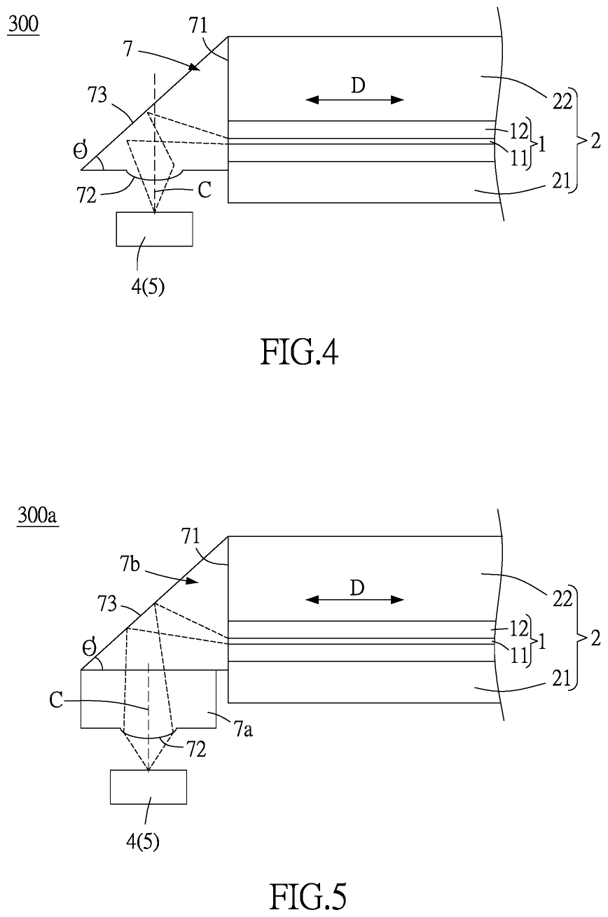

The present disclosure further provides the third embodiment. As shown in FIG. 4, a terminal portion structure 300 of an optical transmission element comprises a light guiding component 1, a glass protection layer 2 and a prismatic convex lens 7.

The light guiding component 1 comprises a core 11 and a cladding 12 enclosing the core 11. The refractive index of the cladding 12 is less than the refractive index of the core 11, allowing light signals to be transmitted in the light guiding components 1 by total internal reflection.

The glass protection layer 2 covers at least the terminal portion of the light guiding component 1. According to the present disclosure, the glass protection layer 2 is divided into a lower lid 21 and an upper lid 22. The lower lid 21 and the upper lid 22 are coupled together to fully enclose the light guiding component 1. However, the present disclosure is not limited thereto, as the glass protection layer 2 may be integrally formed to enclose the light guiding component 1.

The technical features which distinguish the third embodiment from the first embodiment and the second embodiment are as follows: the cross section of the terminal portion of the light guiding component 1 is perpendicular to the axial direction D of the light guiding component 1; the prismatic convex lens 7 is disposed at the terminal portion of the light guiding component 1; and the prismatic convex lens 7 has a connecting side 71, a convex side 72 and a reflecting side 73 opposing the connecting side 71. The connecting side 71 adjoins the cross section of the terminal portion of the light guiding component 1. The reflecting side 73 tilts relative to the axial direction D of the light guiding component 1, thereby forming an included angle θ′ therebetween. The convex side 72 defines a convex lens. The optical axis C of the convex lens is perpendicular to the axial direction D of the light guiding component 1.

The terminal portion structure 300 of an optical transmission element according to the present disclosure is not limited to the emission end or output end, as light signals may enter the light guiding component 1 via the terminal portion structure 300 of an optical transmission element, or light signals in the light guiding component 1 may be emitted from the terminal portion structure 300 of an optical transmission element.

When light signals are emitted from a laser emission element 4 toward the convex lens defined by the convex side 72, the laser emission element 4 can be regarded as a point source. The light signals emitted from the point source are converged by the convex lens defined by the convex side 72 onto the reflecting side 73. The reflecting side 73 tilts relative to the axial direction D of the light guiding component 1, such that the light signals from all angles undergo total internal reflection on the reflecting side 73, then propagate toward the connecting side 71, and finally converge at the core 11, thereby allowing the light signals to propagate in the axial direction D of the light guiding components 1 toward the remote end.

By contrast, when the light signals from the remote end propagate in the axial direction D of the light guiding component 1 toward the terminal portion structure 300 of an optical transmission element, the light signals from all angles propagate in the prismatic convex lens 7 from the connecting side 71, undergo total internal reflection on the reflecting side 73, and thus propagate at all angles toward the convex lens defined by the convex side 72. The convex lens defined by the convex side 72 converges the multi-angle propagating light signals at a light signal receiving element 5.

According to the present disclosure, the terminal portion structure 300 of an optical transmission element increases the tolerance of the distance between the laser emission element 4 or light signal receiving element 5 and the light guiding component 1, increases the tolerance of the inclination angle of the reflecting side 73 of the prismatic convex lens 7, broaden the application of the terminal portion structure 300 of an optical transmission element to various laser emission elements 4 or light signal receiving elements 5, render assembly and manufacturing easy, and downsize related elements. According to the present disclosure, the terminal portion structure 300 of an optical transmission element is applicable to multiwave multiplexing (sending beams of light signals of different wavelengths simultaneously from one single optical fiber or wave guiding) and multiwave demultiplexing (dividing a group of light signals of different wavelengths into several light signals of specific wavelength), but the present disclosure is not limited to one single optical fiber transmission.

In this embodiment, the included angle θ′ between the reflecting side 73 and the axial direction D of the light guiding components 1 is less than 44 degrees, preferably 42.5±0.5 degrees.

In an aspect of this embodiment, the prismatic convex lens 7 is an integrally formed prism. However, the present disclosure is not limited thereto. As shown in FIG. 5, in another aspect of this embodiment, the prismatic convex lens for use with the terminal portion structure 300 of an optical transmission element is a combination of a multi-faceted prism 7b and a convex lens 7a.

While the present disclosure has been described by means of specific embodiments, numerous modifications and variations could be made thereto by those skilled in the art without departing from the scope and spirit of the present disclosure set forth in the claims.

What is claimed is:

1. A terminal portion structure of an optical transmission element, comprising:
a light guiding component comprising a core and a cladding enclosing the core, wherein refractive index of the cladding is less than refractive index of the core, allowing light signals to be transmitted in the light guiding component by total internal reflection;
a glass protection layer covering at least the terminal portion of the light guiding component; and
a convex lens disposed on a side of the glass protection layer,
wherein a cross section of the terminal portion of the light guiding component tilts relative to an axial direction of the light guiding component, and an optical axis of the convex lens is perpendicular to the axial direction of the light guiding component.

2. The terminal portion structure of an optical transmission element according to claim 1, wherein the focal point of the convex lens is located at the cross section of the terminal portion of the core.

3. The terminal portion structure of an optical transmission element according to claim 1, wherein an included angle between the cross section of the terminal portion of the light guiding component and the axial direction of the light guiding component is less than 44 degrees.

4. The terminal portion structure of an optical transmission element according to claim 1, further comprising a laser emission element facing the convex lens.

5. The terminal portion structure of an optical transmission element according to claim 1, further comprising a light signal receiving element facing the convex lens.

6. The terminal portion structure of an optical transmission element according to claim 1, wherein the light guiding component is in a plural number, and the light guiding components are arranged in parallel, with the glass protection layer covering at least the terminal portions of the light guiding components.

7. The terminal portion structure of an optical transmission element according to claim 6, wherein the glass protection layer has a plurality of V-shaped grooves parallel to the light guiding components.

8. A terminal portion structure of an optical transmission element, comprising:
a light guiding component comprising a core and a cladding enclosing the core, wherein refractive index of the cladding is less than refractive index of the core, allowing light signals to be transmitted in the light guiding component by total internal reflection;
a glass protection layer covering at least the terminal portion of the light guiding component; and
a convex lens disposed at the cross section of the terminal portion of the light guiding component,
wherein the cross section of the terminal portion of the light guiding component is perpendicular to an axial direction of the light guiding component, and an optical axis of the convex lens is parallel to the axial direction of the light guiding component.

9. The terminal portion structure of an optical transmission element according to claim 8, wherein the focal point of the convex lens is located at the core.

10. The terminal portion structure of an optical transmission element according to claim 8, wherein the convex lens adjoins the cross section of the terminal portion of the light guiding component.

11. The terminal portion structure of an optical transmission element according to claim 8, further comprising a pad disposed at the convex lens and on the cross section of the terminal portion of the light guiding component.

12. A terminal portion structure of an optical transmission element, comprising:
a light guiding component comprising a core and a cladding enclosing the core, wherein refractive index of the cladding is less than refractive index of the core, allowing light signals to be transmitted in the light guiding component by total internal reflection, wherein the cross section of the terminal portion of the light guiding component is perpendicular to an axial direction of the light guiding component;
a glass protection layer covering at least the terminal portion of the light guiding component; and
a prismatic convex lens disposed at the terminal portion of the light guiding component and having a connecting side, a convex side and a reflecting side opposing the connecting side, the connecting side adjoining the cross section of the terminal portion of the light guiding component, the reflecting side tilting relative to an axial direction of the light guiding component, and the convex side defining a convex lens, wherein an optical axis of the convex lens is perpendicular to an axial direction of the light guiding component.

13. The terminal portion structure of an optical transmission element according to claim 12, wherein the prismatic convex lens is an integrally formed prism.

14. The terminal portion structure of an optical transmission element according to claim 12, wherein the prismatic convex lens is a combination of a multi-faceted prism and a convex lens.

15. The terminal portion structure of an optical transmission element according to claim 12, wherein an included angle between the reflecting side and the axial direction of the light guiding component is less than 44 degrees.
